(19) United States
(12) Patent Application Publication
(10) Pub. No.: US 2015/0154956 A1
(43) Pub. Date: Jun. 4, 2015

(54) AUTO-TAGGER THAT LEARNS

(71) Applicant: Cellco Partnership d/b/a Verizon Wireless, Basking Ridge, NJ (US)

(72) Inventor: Deborah Washington Brown, Alpharetta, GA (US)

(73) Assignee: Cellco Partnership d/b/a Verizon Wireless, Basking Ridge, NJ (US)

(21) Appl. No.: 14/095,483

(22) Filed: Dec. 3, 2013

(51) Int. Cl. G10L 15/26

(52) U.S. Cl. CPC G10L 15/26

(57) ABSTRACT

Examples perform context categorization by categorizing a transcription of a speech file based on the context of the subject matter of the transcription. A computer processor is configuration to provide a system that generates a normalized transcription of the speech file transcription and compares elements of the normalized transcription to elements of a context categorization model or a corpus of categorized transcriptions to determine whether the normalized transcription contains keywords of transcriptions that have previously been categorized. If the comparison yields a result indicating a specific match with a context category, the normalized transcription is assigned to the matching context category. As the number of successfully categorized transcriptions stored in the corpus increases, the more frequently the system and method examples perform successful comparisons. As a result, the context categorization accuracy increases and the system appears to learn.

### BACKGROUND

In recent years, as the number of on-line services that are provided by various entities increases, the amount of support to be provided to subscribers and other customers of the various services or to potential customers also increases. The customer support provided by the service providers may be in the form of on-line support or telephone call center support.

Presently, call centers allow callers to speak their problem or request in plain language, and equipment analyzes the speech input to route each call to the correct support service destination (e.g., agent queue, tutorial, or application) based on a recognition of the inputted text. At least in some types of natural language call routers, speech recognition equipment detects words in a caller's spoken input; and the equipment compares a string of detected words or one or more keywords from a string of detected words obtained from the spoken input to a predefined set or database of phrase or words. Each of the phrases of words in the predefined set is assigned to or tagged for a particular destination, and a match of the input to such a controlled phase or word causes the router to direct a call to the particular destination.

The accuracy of the voice recognition ability of the call center to correctly assign destinations to self-serve callers' speech has an impact upon self-serve caller satisfaction. Over time, caller demographics change and/or new technologies and services are introduced, and the call center voice recognition and destination assignment accuracy may deviate from an expected accuracy. The performance of the call center is monitored and periodically assessed in order to make the appropriate adjustments with respect to the voice recognition results and the destination assignments.

In order to make a performance assessment, thousands of samples of callers' speech must be transcribed and “tagged”. In such a context, tagging is in the process of determining what the correct destination should have been for the self-service caller that has provided a particular speech input. At a later date, the tagging results are compared to the actual destination routing of the same self-service caller by the call center equipment, to determine the accuracy of the call center destination routing. The call center performance assessment may be made, in part, based on the accuracy determination. Over time, either as caller speech patterns change or as the services offered by the center change, the operator of the center may also need to change or add new tagged files to match potentially new speech inputs from callers. Such an update or change also may require input, tagging and storage of many transcribed speech files.

Unfortunately, tagging is presently an essentially manual process and requires a measure of expertise and knowledge about the application in addition to being time consuming.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 is a high-level functional block diagram of an example of a system for natural language call context categorization that provides a process for automatic transcription categorization and support for examples of a context categorization process.

FIG. 2 is a high-level functional process flow diagram of an example of a generalized system, implementing examples of a context categorization process.

FIG. 3 is a process flowchart of an example of a context categorization process.

FIG. 4 is a process flowchart of another example of a context categorization process.

FIG. 5 is a process flowchart of yet another example of a context categorization process.

FIG. 6 is a simplified functional block diagram of a computer network system that may be configured to implement the functions as described with respect to FIGS. 2-5.

### DETAILED DESCRIPTION OF EXAMPLES

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

In general, there is a need to simplify and automate as much of the context categorization (i.e. tagging) process as possible while maintaining a high degree of accuracy.

At a high level, a natural language call router provides a computer application in which a caller to a customer support call center can speak his/her concerns naturally (that is, without aid of a menu). In response, the call router then transfers the caller to the appropriate point in the application, or routes them to the appropriate customer representative queue, or takes them to a self-service application. By frequently monitoring and measuring the accuracy of the natural language call router system, problems areas are quickly identified and the necessary adjustments may be made to maintain optimal performance. However, because of the large manual effort required, categorizing transcriptions of possible speech inputs is the biggest bottleneck to monitoring and measuring the system performance. As a result, a complete analysis of the system's performance is done infrequently. By substantially decreasing the amount of manual effort required to categorize the caller's speech, it is possible to evaluate and optimize performance more frequently.

The successful routing of a call is dependent, in part, on a successful assignment of a call to a context category. A context category is a high-level classification of a transcription that identifies the context of the transcription and corresponds to the tagging of the transcription for use of the transcription to control routing by a natural language call router. The context category may indicate a general context of the transcription, such as an e-mail problem, or may indicate the context with more specifically, such as e-mail synchronizing problem. A large number of transcriptions may be assigned to a single context category. Practically, the context category is a shorthand indicator of the subject matter context of a transcription. Examples of context categories can include general billing, technical e-mail, billing problem, e-mail bill, operator, television subscriber, television upgrade, internet subscribe, internet subscribe, internet problem, technical internet, cancellation internet, cancellation television, telephone upgrade, and the like.

The various examples disclosed herein relate to assigning context categories to transcription, of recognized speech for future recall and increased accuracy.

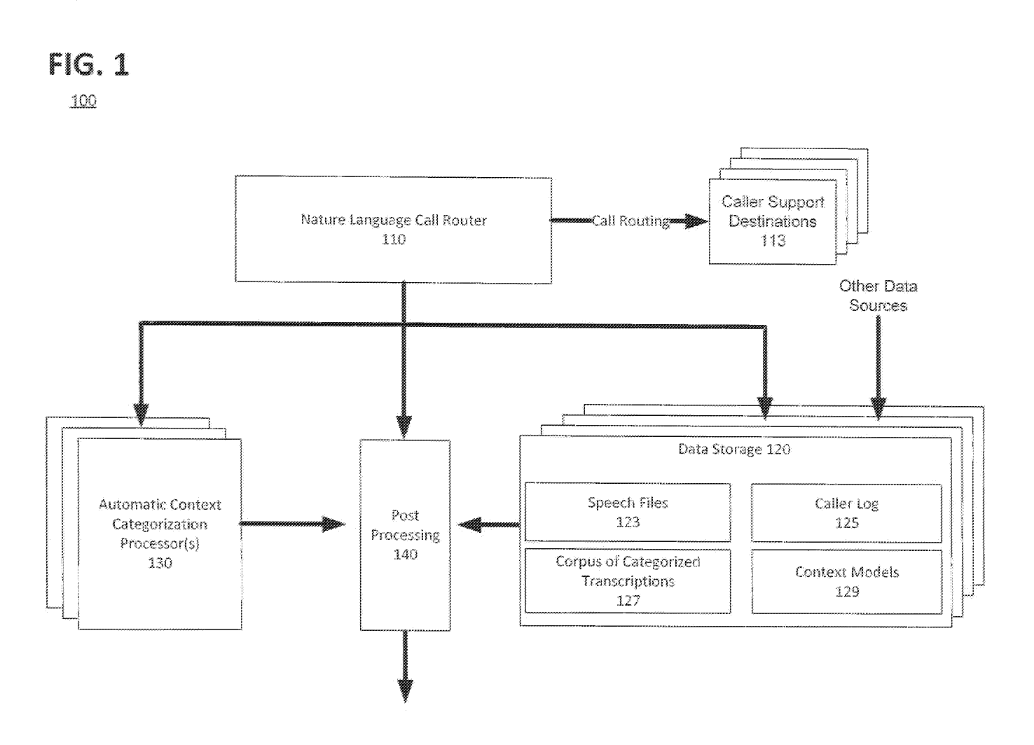

Reference now is made in detail to the examples illustrated in the accompanying drawings and discussed below. FIG. 1 illustrates a high-level functional block diagram of an example of a system of natural language telephone call context categorization that provides a process for automatic transcription categorization and support for examples of a context categorization process. The high-level system 100 includes, among other components, a natural language call router 110, caller support destinations 113, a data storage 120, an automatic context categorization processor(s) 130, and a post processing 140 system. In general, the system 100 may be implemented by, for example, a service provider entity, such as a cable television provider, a digital content provider, a cellular telephone service provider, a retail store, a credit card company, government agency and the like, or a third-party supporting a service provider entity, to facilitate the routing of subscriber or customer (i.e. users) telephone calls to the appropriate customer support service representative (or automated self-service application) for handling the specific subscriber or customers inquiry. The system 100 may be implemented by one enterprise or a group of enterprises (e.g. one entity may utilize the natural language call router 110 for in-bound call processing to its call center but obtain the results of transcript categorization from another entity operating other elements of the system 100).

When routing calls, the natural language call router 110 utilizes speech recognition algorithms provided by the automatic context categorization processor(s) 130 to recognize a caller's speech inputs. The automatic context categorization processor(s) 130 may also identify a context category (i.e. tag) that corresponds to the respective recognition result. For example, the recognition algorithms executed by the automatic context categorization processor(s) 130 may access data in the corpus of categorized transcriptions 127 or context models 129 to perform the recognition. Each of the caller support destinations 113 is configured to handle issues related to one or more of the respective context categories. Based on the correspondence between the identified context category and the respective caller support destination 113, the call is routed by the natural language call router 110 to the corresponding call support destination 113, for example, for resolution by a customer support representative or another computer application.

The natural language call router 110 also provides data related to the calls received from users to the data storage 120, the automatic context categorization processor(s) 130, and/or the post processing 140. For example, the natural language call router 110 may record caller utterances describing the caller's reasons (e.g., service problem, sign up for new services, compliment a worker, and the like) for calling that are subsequently stored as data records in the data storage 120 as speech files 123. The data storage 120 also stores information related to a call from a caller, such as a call identifier, a call time, and duration, in a caller log 125. The data storage 120 also contains data records, or ides, related to a corpus of categorized transcriptions 127 and context models 129. For example, the corpus of categorized transcriptions 127 contains a large number of examples of received telephone call transcriptions that have been confirmed by the system as being correctly assigned to a context category. Alternatively, other processes may access the data to perform an analysis using the data, such as, for example, a statistical analysis.

As described herein, assignment of a transcription to a context category, or vice versa, is referred to as “tagging” and as a result of “tagging” and a “tagged transcription” is a transcription that has been assigned to a specific context category represented by the “tag.” The correctness of the assignment to the particular context category for a particular transcription may be based on an analysis of a context model obtained from the context models 129 in data storage 120.

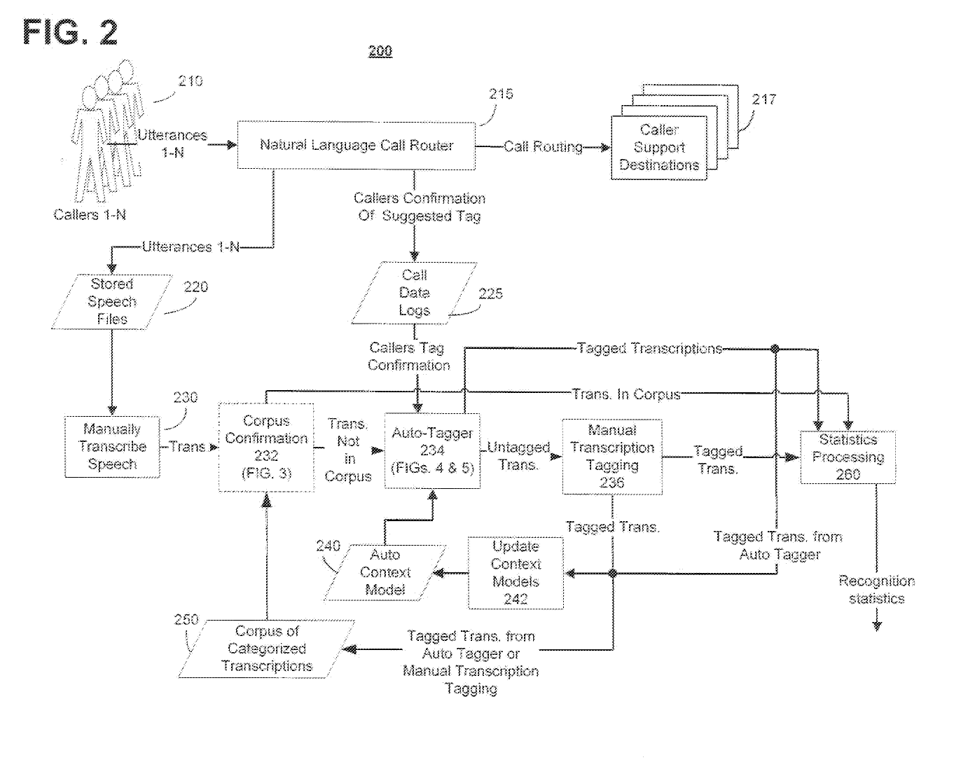

A context model, in some examples, is an exemplar that meets the requirements for the assignment of transcript to a specific context category for use in natural language call routing in response to later input of spoken words found in the transcript. For example, a context model in the context models 129 may be a data record that includes a list of keywords that are typically found in a transcription that is assigned to the specific context category. A more detailed description of the assignment of context categories, transcription, keywords, context models and the corpus of transcriptions will be made with respect to FIGS. 2-5. The data storage 120 may also receive data such as context category updates, or other transcriptions from other sources. For example, another service provider or system may provide transcriptions for inclusion in the corpus of categorized transcriptions 127. This provides additional samples of categorized data to which newly received transcripts can also be compared. As a result, the system may become more efficient at categorizing the newly received transcriptions because of the larger number of samples of categorized data.

The automatic context categorization processors 130 may perform a variety of functions related to categorizing transcriptions of the substance of the user calls. For example, using the recorded audio of the user call stored in the speech files 125, and user information provided during the call, a transcription of a stored speech file may be made and provided to automatic context categorization processing 130. The automatic context categorization processor 130 may perform some processing related in the provided transcription that is described in more detail with regard to FIGS. 2-5. For example, the automatic context categorization processors 130 use data stored in the data storage 120 to perform processing of each provided transcription. By way of a general example, an automatic context categorization processor 130 performs a sequence of processes as discussed below in more detail using context models 129 obtained from the data storage 120. Once the procedure is performed, information generated by the processors may be added to a corpus of categorized transcriptions 127 and used to update the context models 129 in data storage 120. The automatic context categorization processors 130 may send data related to the disclosed processes, and other data, such as the number of transcriptions in a particular context category, to the post processing 140. Post processing 140 may include generating and analyzing statistics related to the provided transcriptions.

A general process flow of context categorization will now be described with reference to FIG. 2, which is a high-level functional process flow diagram of an example. In the functional process flow 200, each of the processes 210-260 may be performed by one or more processors and/or servers, and the described data records may be maintained in one or more databases. For example, the auto-tagger 234 process may be performed by one or more processors in combination with a data storage with respect to the call data logs 225.

In the functional process flow 200, a plurality of telephone calls from a plurality of callers 210 (e.g. callers 1-N) are received by the natural language call router process 215. The natural language call router 215 process receives the calls and the related utterances 1-N from the callers 1-N. The natural language call router 215 performs a variety of functions, such as call routine and assessment data generation related to the utterances 1-N.

In one instance, the natural language call router 215 performs a call routing function that routes incoming calls from callers 1-N to respective call support destinations 217. During call routing, the utterances 1-N corresponding to the respective callers 1-N are recognized by a recognition process (not shown), such as a speech-to-text algorithm. The actual routing process may use the corpus of categorized transcriptions database 250 and/or the auto context model database 240 to perform a textual comparison of the words detected by speech recognition processing of the respective utterances 1-N to the texts stored in the corpus. Based on a successful comparison results, an expected context categorization of each respective utterance may be determined. Using the context categorization of each of the respective utterances 1-N, the natural language call router 215 routes each of the respective callers 1-N to a call support destination 217 that is intended to responds to calls related to the respective context categorization. For example, the neutral language call router 215 may recognize the input utterance of “Late charge on bill,” from a caller; and, after consulting the corpus of categorized transcriptions database 250, assign the input utterance to a context category named “Bill Problem”. Each of the call support destinations 217 responds to a specific set of context categories. If the destinations are agents' terminals, for example, the persons in the call support destinations 113 can develop or already have expertise with handling caller requests corresponding to the specific set of context categories. In the example of a call where the caller input the utterance “Late charge on bill,” the natural language call router 215 would route the call to the call support destination 113 that handles the “Bill Problem” context category.

In another instance, the natural language call router 215 provides data for improving recognition results and/or for performance assessment. In this instance, audio files of the utterances 1-N are made and are stored in, for example, data storage 120 as stored speech files 220 (i.e. 123 of FIG. 1). In addition, call data logs 225 related to the received call speech 1-N are maintained. The call data logs 225 may contain data related to the received call and how the call was processed by the natural language call router process 215. For example, the call data log for a particular call may include a caller's account number, if any, or some identifier of the caller, a call identifier, such as a time stamp and/or call number, an indicator of whether the reason for the call was resolved, a caller's confirmation of a suggested context category tag, related to the subject matter of the call, and other data.

With regard to the caller's confirmation of a suggested context category tag, the natural language call router process 215 may, based on the nature of the call, inquire of the caller whether the call is in relation to a particular context category. Of course, the caller may or may not provide a response to the inquiry, and if a response to the inquiry is provided, nothing prevents the caller from providing an inaccurate response. For example, in order to receive assistance sooner with their voice-mail problem, the caller may respond with the first choice in an alphabetical list of context category choices (not likely to be “voicemail”). Even though the context category provided is incorrect, the call data log 225, in data storage, retains the incorrect context category as the caller's tag confirmation in a data record related to one of the speech files 1-N.

The speech files 1-N are stored in the stored speech files 220 with other speech files. The stored speech files 220 may be raw audio recordings of the utterances 1-N from the callers 1-N. In the manual transcribe speech process 230, each stored speech file 220 is manually transcribed to provide a call transcription. The call transcription may be provided to the corpus confirmation process 232.

The corpus confirmation process 232 is a functional process that confirms whether a transcription is already within the corpus of categorized transcriptions 127. For example, a pair of callers (e.g. callers #3 and #77) from among callers 1-N may have the same issue (e.g. a voicemail problem) and may use the exact same terms/phrase/sentence in their speech (e.g. “I'm having a voicemail problem.”) to describe the issue to the natural language call router 215 process. The speech file generated front caller #3 may be transcribed, assigned a context category (i.e. tagged) by the functional process flow 200, and stored in the corpus of categorized transcriptions 250 (127 of FIG. 1). When call #77 is transcribed, the functional process flow 300 will determine whether or not the call #77 transcription is already saved in the corpus of categorized transcriptions 250 (e.g. by recognizing a match of the #77 transcript to the transcript of the input from caller #3).

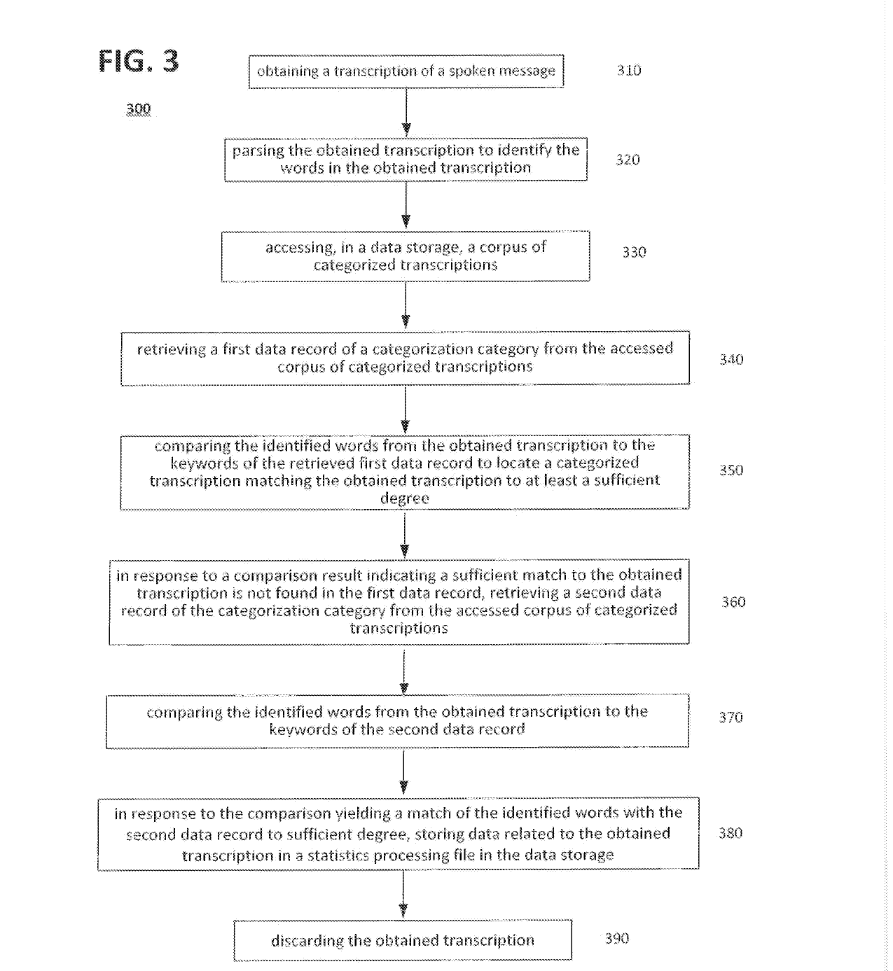

There are a number of methods of determining whether or not a match to the call #77 transcription is already saved in the corpus of tagged transcriptions 250. FIG. 3 illustrates a process flowchart of an example of a context categorization process. In the example, a method for determining whether or not a call transcription is substantially equivalent to the call #77 transcription that is already saved in the corpus of tagged transcriptions 127 is shown. The corpus confirmation of the context categorization process 300 includes a processor obtaining a transcription of a spoken message for assigning a context category to the transcription (310). Each of the transcriptions provided by the manually transcribed speech process 230 of FIG. 2 may be a literal transcription, which is a transcription that may include substantially every recognizable word of the speech input that is in the respective speech file stored in speech files 123. Alternatively, each of the transcriptions may be a normalized transcription, each of which is a transcription that has had normalization rules applied to the words in the literal transcription. For example, when original transcriptions are stored, a conversion of the original transcription to a normalized transcription is performed by auto-tagger process 234. Alternatively, normalized transcriptions may be generated by a separate process (not shown) that occurs after the manual transcribe process 230, but prior to execution of the auto-tagger process 234. In which case, auto-tagger process 234 may access a data storage to retrieve the normalized transcription. In any example, the literal transcription is available to any of the processes 230-260. In specific examples, the manual transcription tagging 236 and the statistical processing 260 processes use the literal transcription.

The following paragraphs provide an explanation of some of the terms used to describe the disclosed examples of a context categorization process. A normalized transcription may take a number of forms. As an example, a transcription may be normalized by applying normalization rules to the literal transcription. A first normalization rule may, for example, remove words that are unessential to, or may he ignored when, determining the meaning, or context, of the literal transcription. Said differently, the removed words are words that the algorithm can ignore when determining the context of the transcription for categorization purposes. For example, the unessential words that may be parsed from the transcription may be words such as articles (e.g. “a”, “the”, “an”), one-word propositions (e.g. “for” or “of”), and/or conjunctions (e.g. “and”, “but”). Of course, other types of or forms of words may be used either separately or in combination with the prior example of determining an unessential word.

From the words remaining in the partially normalized transcription (i.e. essential words), a set of one or more keywords that are words that can be transformed into a root word by applying one or more additional normalization rules are determined. For example, additional normalization rules applied to the remaining essential words may include parsing the essential words to determine whether an essential word is enhanced. In the following examples, an enhanced essential word is an essential word that has a suffix, a prefix an infix, or a combination thereof, and an enhancement of the essential word is the suffix, the prefix, the infix, or the combination thereof. An unenhanced essential word is an essential word that does not have a suffix, a prefix, or an infix. The processor may be configured to identity when parsing the remaining essential words to identify a suffix or prefix in any essential word, and removing the suffix or prefix to provide a root word. For example, the essential word may contain as a suffix, in the form of a final “-s”, “-ing” or “-ion” that is removed from the essential word. An aim of the additional normalization rules is to arrive at a common set of keywords. In some cases, the removed suffix may be replaced, e.g. to change a word ending in ‘ion’ or ‘ing’ to a corresponding verb that happens to end in ‘e’. Similarly, the processor may also be configured to determine when an essential word is unenhanced. In which case, a comparison of the unenhanced essential word to a dictionary is performed to determine if the unenhanced essential word is in the shortest form.

In some examples, the shortest form of the essential word is stored as a keyword in a data record to provide the normalized transcription data record of the literal transcription. For example, as another normalization rule, a dictionary may be examined to identity a shortest form of an essential word by modifying a root word. The dictionary comparison may yield a match that requires the additional action of replacing the final “—ing” or “—ion” with an “e” at an end of a word (e.g. “typing” becomes “type”). In another example, a dictionary is not examined and the word is considered to be in a shortest form after the normalization process. In another example, when a dictionary is considered, all instances of a shortest form of an essential word are stored in the data record as keywords, so duplicate keywords may be present in the data record. Similarly, in examples, in which a dictionary is not considered, duplicate copies of essential words are stored in the data record as keywords, so duplicate keywords may be present in the data record. After the application of the additional normalization rules, only one instance of the same keyword is needed; so if there are extra, or multiple, occurrences of the same keyword stored in the data record, the extra occurrences of the keyword may be deleted. Alternatively, prior to storing the shortest form of the essential word, the data record is analyzed to identify any duplicates of the shortest form of the essential word in the keywords stored in the data record. In response to identifying a duplicate of the shortest of the shortest form in the keywords already stored in the data record, the keyword in the data record is left in the data record, and the latest shortest form of the essential word is discarded.

In an example, the literal transcription of a speech file may be, “I am having a problem e-mailing. E-mail problems.” The unessential words, “I”, “am” and “a” are removed, which leaves the words “having”, “problem”, “e-mailing”, “E-mail” and “problems.” Applying the above additional normalization rules—“having” becomes —have—, “problem” is left unchanged as —problem—, “e-mailing” becomes —e-mail—, “E-mail” is left unchanged as —problem—, and “problems” becomes —problem—. An understanding of the context of the transcription is not enhanced by multiple occurrences of the keywords —e-mail— and —problem—, therefore, the occurrences of each respective keyword greater than one occurrence can be deleted, in which case, in order to understand the context of the literal transcription in the example, only three (—have—, —problem—, —e-mail—) of the five remaining keywords are retained. In some examples, the verb —have— and other auxiliary verbs may also be considered as unessential words, and may be deleted. Continuing with the example, the keywords in the normalized transcription N are —problem— and —e-mail—.

In some situations, a literal transcription already has the features of a normalized transcription. For example, a caller having an e-mail problem may only say, “E-mail problem” when contacting the natural language call router 110. In which case, none of the first or the subsequent normalization rules reduce the literal transcription to a set of keywords. As a result, the resulting normalized transcription is the same as literal transcription. However, in this example, the system does not determine a similarity of the literal transcription to the normalized transcription, and the system continues the process using the normalized transcription. Although, in other examples, the system may determine a similarly measure between the literal and normalized transcriptions, and if similar to a sufficient degree, may continue using the literal transcription only. Alternatively, both the literal and normalized transcriptions may be used in some examples.

In a database, the context category may be the higher-level (i.e. parent or child) classification data record and the normalized or literal transcription may be included in a lower-level (i.e. child or grandchild) data records.

In an example, the lower-level data records are context model data records. An individual context model data record is one of many data records assigned to a single context category of a plurality of context categories. Each context model data record contains keywords that indicate the subject matter context of the respective spoken message and the single context category to which it is assigned.

In addition to, or alternatively, data may be organized as data records that include, for example, an identifier (ID), keywords of a normalization transcription and as assigned context category (i.e. a Tag). In order to limit confusion, a normalized transcription can only be assigned to one context category. For example, context model data records in the context category of “Billing Problem” may take the form as shown in the following table:

TABLE 1

| ID. | Keywords | Context Category (i.e. Tag) |
|---|---|---|
| 1 | {“bill”, “problem”} | Billing Problem |
| 2 | {“bill”, “high”} | Billing Problem |
| 3 | {“bill”, “wrong”} | Billing Problem |

Of course, additional data such as the literal transcriptions, context sub-categories (e.g. billing problem internet), timestamp and the like may be included in the context model data record. For purposes of categorizing a transcription, the normalized transcription and context category provide sufficient, detail for a successful categorization. A data record organized similar to or the same as the data records shown in table 1 are stored in the corpus of transcriptions and the context model. The arrangement of the respective databases forming the corpus and the context model may be the same or different and may be operated on differently by different processes as described below with respect to FIG. 2. For example, the corpus data records may be searched for any normalized transcription matching a received transcription, while the context model data records will only be searched for a match to a normalized transcription in a particular context category. Or, the context model data records may, first, be searched b context category, then by keywords. While the corpus data records may be searched by keywords from the normalized transcription or by all words in the literal transcription, and then by context category.

Returning to FIG. 3, the obtained transcription is parsed to identify the words in the obtained transcription (320). From data storage, a corpus of categorized transcriptions is accessed (330) by a processor. To summarize, the corpus of categorized transcriptions is a hierarchical database organized by context category at the highest level. Each context category includes at a lower level containing a plurality of data records related to transcriptions that have already been assigned to the higher context category (i.e. categorized transcriptions). For example, when accessing the corpus of categorized transcripts, the processor may identify a first categorization category at a highest level of a hierarchical database, and then identify the first data record of the categorization category for processing. The context model database 240 may be organized in a hierarchical fashion similar to the corpus. However, the context model database may be organized with keywords (e.g. “billing”) at the highest level under which are listed a plurality of context categories that have data records that include the keyword (“billing”) as well as other keywords (e.g., {“billing”, “problem”}; {“error”, “billing”} and the like).

The corpus of categorized transcriptions provides a database usable by the system to more accurately recognize a correct context category for assignment a transcription. The accuracy increases because of the additional examples of correct context category assignments are added to the corpus database. The data records in the corpus database may include a variety of data related to a transcription and the context categories. In an example, a corpus data record includes a keyword field and a category field. In another example, the corpus data records may include additional information, such as literal transcriptions (i.e. all words from the speech file) and keywords from normalized transcriptions, timestamps related to the literal and/or normal transcription, a transcription author, anonymized geographical information associated with the transcription, and the like.

A first data record of a categorization category is retrieved from the accessed corpus of categorized transcriptions (340). The words from the obtained transcription identified in step 320 are compared to keywords of the retrieved first data record in an attempt to locate a categorized transcription matching to a least a sufficient degree the obtained transcription (350).

The criteria for a match to be at least a sufficient degree may involve one or more different criterion. For example, a match to a sufficient degree may be an exact match of all keywords in the context model to the keywords in the normalized obtained transcription, and the exact match is required to return a successful match result. Alternatively, a match to a sufficient degree may be considered percentage or a probability of match (e.g. >75%, >80%, >95% or the like) of keywords in the context model match to the keywords in the normalized transcription. Of course, some other indicator of sufficient degree, such as a decimal indication of a probability, a ratio, a change in the number of keyword matches needed to form a subset or superset, and the like, may be used to indicate the degree of matching that satisfies a threshold. Alternatively, the matching criteria may be a combination of different matching criteria, for example, a combination of set matching and probability thresholds. In another alternative, the matching criteria or probability thresholds may be dynamically adjusted by the system based on a system determination that certain data is affecting the context categorization. For example, the system may track the number of times the speaker provided a correct suggested context category match criteria. Based on a system determination that the context category suggested by the speaker is consistently satisfying the matching criteria threshold, the matching criteria (a set matching threshold or probability threshold) may be adjusted by the system based on the suggested context category. The math parameter settings may be set by a user via a graphical user interface to the system. For example, the automatic context categorization processor(s) 130 may incorporate match parameters to perform a matching process. These match parameters may include settings for percentage probability of match, customized settings including specific matching criteria, and the like. The user interface may include a field; or other user input (e.g. a slider, a radio button and the like), into which a user can enter or select a change to the match parameter settings.

Of course, more complex matching criteria may be formulated. For example, the matching criteria may be satisfied when one or more conditions of the following conditions are met. The matching conditions may be, for example, based on set theory. For example, the conditions may be that a match involves a subset or superset of keywords. In more detail, the matching criteria of a disclosed example include a first condition and a second condition. The first condition in the example is satisfied when a match of the keywords in the categorized transcription of the context model form a subset of the keywords in the normalized obtained transcription. For example, there is a subset match when a subset of the context model keywords is included in the keywords of the normalized transcription. The second condition is when the keywords in the categorized transcription are a superset of the normalized obtained transcription. In other words, there is a superset match.

The following example provides an illustration of the two conditions: a subset match and a superset match. The natural language call router 110 receives a call from a caller, and the resulting transcription provides “speak to a representative.” The normalized transcription N results in keywords of (N={“speak” and “representative”}). A sample of the context models for the context category “Operator” includes IDs. 1-3 shown in Table 2 below.

TABLE 2

| ID. | Keywords | Context Category (i.e. Tag) |
|---|---|---|
| 1 | {“representative”} | Operator |
| 2 | {“speak”, “customer”, | Operator |
| | representative”} | |
| 3 | {“talk”, “someone”} | Operator |

By applying the above described set matching conditions to the normalized transcription N={“speak” and “representative”}, the context model ID 1 keyword is a subset of the keywords in N, and the context model ID 2 is a superset of the keywords in N. In some examples, the comparison algorithm generates an indication of which type (e.g. a subset match or superset match) of match is the match result when a matching subset is found or a matching superset is found, and if both types of matches are found, two indications are generated. Alternatively, when both match conditions are satisfied, the comparison algorithm returns a “YES” value or similar indication indicating that context category “Operator” is the correct context category for the transcription “speak to a representative”. Conversely, if both of the match conditions are not satisfied, the comparison algorithm would return a “NO” value or similar indication that the context category “Operator” is not the correct context category for the transcription “speak to a representative.”

Returning to the discussion of FIG 3, if no matches to a sufficient degree are found in the first data record, a processor retrieves a second data record of the context category from the corpus of categorized transcriptions (360). The identified words from the obtained transcription are compared to keywords in the second data record of the context category (370).

In the example, a keyword comparison between the keywords in the obtained normalized transcription and keywords in one of the context models assigned to the second context category yields a match result to sufficient degree. In response to the comparison yielding a match, data related to the obtained transcription is stored in a statistics processing file in the data storage (380). Since a matching transcription has been identified in the corpus and data related to the obtained transcription has been stored in the statistics processing file, the obtained transcription data record may be discarded (390).

Returning to the functional process flow 200 of FIG. 2, when the corpus confirmation process 232 receives an indication of the matching failure, an indication that a match to a sufficient degree for the obtained transcription is not found in any of the context categories in the corpus is sent to the auto-tagger process 234. The auto-tagger process 234 may obtain a transcription either directly from the manual transcribe speech process 230, or, when a transcription is not located in the corpus of categorized transcriptions 127, from the corpus confirmation process 232.

As shown in FIG. 2, the auto-tagger process 234 retrieves and/or receives data from the call data logs database 225 and/or the auto context model database 240. The auto context model database 240 contains a number of context model data records that are individual data records. Each context model data record contains at least a set of keywords that indicate the subject matter context of a normalized transcription and an indicator of a single context category to which the context model is assigned. The input received from the call data logs database 225 may be provided in response to a request for data related to a specific transcription sent from a processor. For example, the request may be a request to confirm that a transcription obtained by the auto-tagger process 234 has a caller confirmation of a suggested context category associated with the respective transcription. As a result depending upon the response by the call data logs 225 to the request, the processor may perform one or two tasks. If the call data log 225 database indicates that the caller did provide a suggested context category for the specific obtained transcription, the auto-tagger process 234 confirms that the suggested category is the correct category to be assigned to the specific obtained transcription. Conversely, if the caller did not provide a suggested context category, the processor performs a context category assignment process.

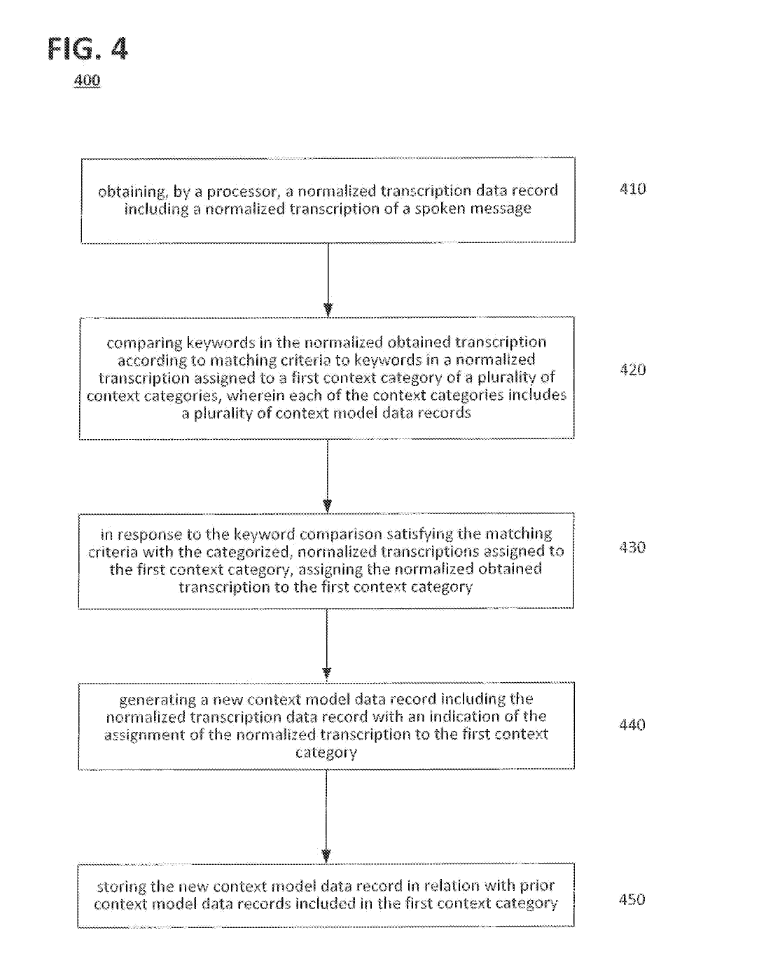

The following describes, with reference to FIG. 4, an example of a process for assigning a context category to a normalized transcription obtained from data storage is shown. In this example, the spoken message transcription is normalized by applying normalization rules as described above. In which cased, the normalized transcription includes a set of keywords. A processor obtains the normalized transcription data record (410). Using matching criteria, comparison are made between keywords in the normalized obtained transcription and keywords in a normalized transcription assigned to a first context category from among a number of context categories (420). The keywords of the normalized transcriptions are obtained from the auto context model database 240. In the example, each of the context categories includes more than one context model data record. Each context model data record includes keywords in a keyword data field and a context category value (in this case, a first context category value) in a context category data field.

The comparisons yield a result of either a match or no match based on matching criteria. The matching criteria are similar to, or the same as, the matching criteria described above with respect to FIGS. 2 and 3. In other words, a subset and a superset match of keywords as described above satisfies the matching criteria. The keywords from the normalized obtained transcription may be compared to keywords of a context model data record as described in the following example.

In the following example, the transcription “my billing statement” is generated from an input utterance, and may be normalized prior to, or after, being received by the auto-tagger process 234. When normalized using the above described normalization rules, for example, the normalized obtained transcription is N={“bill , “statement”}. In this example, the order of the keywords in the normalized obtained transcription N is not relevant to the matching criteria or comparison process. Of course other examples may include matching criteria that take into account the order of the keywords in the normalized transcription. A comparison of the normalized transcription keywords to the keywords of a context model data record is made using matching criteria. In this case, the matching criteria are satisfied when a single context category, or a single tag, data record includes both a context model data record contains all of the keywords in the normalized obtained transcription N (i.e., the keywords of a context model data record is a subset of normalized obtained transcription N) and when the normalized obtained transcription N contains all of the keywords of the context model data record (i.e., when keywords of a context model is a superset of the keywords in the normalized obtained transcription N). For example, table 3 below lists four context category model data records (IDs. 1-4) for the context category labeled “Billing General.”

TABLE 3

| ID. | Keywords | Context Category |
|---|---|---|
| 1 | {“bill”} | Billing General |
| 2 | {“statement”} | Billing General |
| 3 | {“someone”, “statement”, | Billing General |
| | “bill”} | |
| 4 | {“bill”, “problem”} | Billing General |

Referring to Table 3, the context category models in rows 1 and 2 each include keywords that are a subset of the keywords in the normalized transcription N, and the keywords in the context category model in row 3 form a superset of the keywords in the normalized transcription N. So long as one of the context category models is a subset of normalized obtained transcription N, the first of the matching criterion is satisfied. The second matching criterion is satisfied by the context category model in row 3 because it is a superset of the keywords in the normalized obtained transcription N. In other words, a subset is a match in which the keywords in the categorized transcription includes all of the keywords in the normalized obtained transcription N, and a superset match is a match in which the normalized obtained transcription N includes all of the keywords in the categorized transcription.

Returning to the process 400 of FIG. 4, if the comparison of step 420 returns a comparison result as described in the above example related to Table 3, a processor determines that the normalized obtained transcription is to be assigned to the first context category (430). In other words, as a result of satisfying the matching criteria by the context category models assigned to the context category labeled Billing General, a determination is made that the transcription “my email bill” is to be assigned to the context category “Billing General.” Since a successful comparison result has been made, the context category is updated, for example, by the update context models 242 process, based on the indication of the assignment of another another transcription being assigned to the context category as described below.

In response to the assignment determination, a new context model data record is generated (440). The new context model data record is populated with keywords from the normalized obtained transcription N data record (e.g. keywords from the normalization process) and an indication of the assignment of the normalized obtained transcription to the first context category. Alternatively, an existing data record related to either the context category or the normalized obtained transcription N may be updated.

As a result, in the new or updated context category model data record includes, at least a keywords data field populated with the keywords of the normalized transcription and a context category data field populated with the context category indication, for example, as shown in Table 3 above, and the new context model data record is stored in relation with prior context model data records included in the first context category (450).

Referring back to the auto-tagger process 234 of FIG. 2, after completion of the generation of the new context model data record, a data record including the literal transcription and the context category indication is to be forwarded to the statistics processing process 260 and to the update context models process 242 for updating the auto context model database 240. For example, the auto context model database 240 may include more data records related to a specific context category than the corpus of tagged transcriptions 250 database. This may he due to the updates received from the other data sources (shown in FIG. 1), such as third party vendors and/or other entity-related support systems (e.g., speech recognition systems), that provide input to die data storage 120. For example, context categories may be updated or provided with additional keywords or keyword recognition results provided by other entities, such as speech recognition software providers, optical character recognition software providers, keywords and category assignments from systems that correspond with consumers through text messaging and e-mail, or business partners. As a note, the literal and normalized transcriptions may be stored separately. For example, if the normalized transcriptions are stored in the corpus of tagged transcriptions 250, there is essentially no distinction between the corpus of tagged transcriptions 250 and the auto context models 240. Both contain a mapping from the normalized transcriptions to context category identifiers. Alternatively, in other examples, such as that shown in FIG. 2, the literal transcriptions with context category indicators are stored in the corpus of tagged transcriptions 250 and the normalized transcriptions with context category indicators are stored in the update context models 242.

In another example, a failure to satisfy the match criteria is illustrated below. From the previous example, the same normalized obtained transcription is N={“bill, “email”} is being examined, but in comparison to keywords in normalized transcriptions that have different context category assignments than those used in the example related to Table 3. The following table (Table 4) presents four context category models. However, the four context category models are assigned to different context categories.

TABLE 4

| ID. | Keywords | Context Category |
|---|---|---|
| 1 | {“bill”} | Billing General |
| 2 | {“email”} | Tech Email |
| 3 | {“someone”, “email”, “bill”} | Email Bill |
| 4 | {“bill”, “problem”} | Billing Problem |

Based only on a keyword comparison, the context category models in rows 1 and 2 are both subsets of the normalized obtained transcription N, and the context category model in row 3 is a superset of normalized obtained transcription N. However, at least one of the subsets in rows 1 or 2 is not included in a same context category (i.e. Billing General as opposed to Tech Email) as the superset of normalized obtained transcription N (i.e. Email Bill), and therefore the comparison would return with a “NO” match result value.

It a failure to determine a match is the result of the comparisons in step 420, the processor executing the process may forward the transcription data record to the manual transcription tagging 236 process for a manual assignment of the transcription to a context category based on the subject matter of the transcription. During, the manual transcription tagging 236 process, the call may be categorized by another more manual intensive process for future reference. However, consistent manual categorization may be difficult due to the user's subjectivity in the manual categorization process, changes in the categorization terms, and fluctuations in the number of experienced transcribers/categorizers. Therefore, it is advantageous for the auto-tagger 234 to perform the context categorization and confirmations as described with respect to FIGS. 2-5.

As mentioned above with reference to FIG. 2, if a caller confirmation of a suggested context category is not available from the call data log 225 database, the system performs the assignment of a contest category to a transcription as described above with respect to FIG. 4. However, the call data log 225 database may have a caller confirmation of a suggested context category for a corresponding contest category that is passed to the auto-tagger 234 process for confirmation. A processor executing the auto-tagger 234 process may perform a confirmation process to confirm that the suggested context category is a correct, or accurate, suggestion. In this case, the transcription that corresponds to the suggested context category is examined against the context category models for the actual context category that is suggested. A variety of confirmation methods may be used, and FIG. 3 illustrates an example.

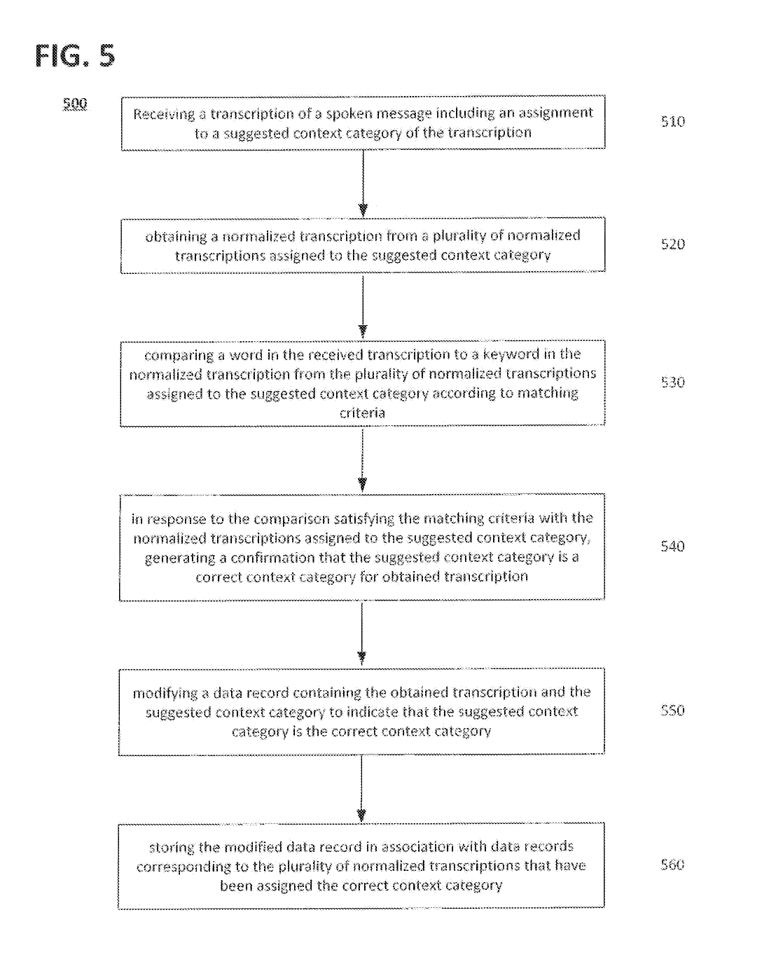

FIG. 5 is a process flowchart of yet another example of a context categorization process. In particular, a process for confirming a context category provided by a caller is accurate is disclosed.

In the process 500, a transcription of a spoken message is received from, for example, the manual transcriber 230 process of FIG. 2 or obtained from data storage 120 of FIG. 1 (510). The transcription is stored in a data record and may or may not be normalized. The data record also includes an indication of a suggested context category assignment for the respective transcription. The suggested context category provides the system with a preliminary indication of the subject matter context of the transcription of the call. The indication is based on a caller confirmation of a context category suggested by the system. For example, the natural language call router 215 may present a question (verbally or via a text) to a caller 1-N after the caller has provided the speech 1-N, such as “Let me make sure we are routing your call correctly. Are you having a problem with e-mail” or similar language. If the caller confirms the suggested context category, the suggested context category is preliminarily assigned to the transcription.

In order to confirm the suggested context category, a processor obtains a normalized transcription from the one or more normalized transcriptions assigned to the suggested context category (520). The normalized transcription may be obtained from either the corpus of categorized transcriptions 127 or the context category model database 129. Data records in either the corpus of categorized transcriptions 127 or the context category model database 129 may be organized as discussed above. Using the obtained normalized transcription, a word in the received spoken message transcription is compared to a keyword in the obtained normalized transcription according to matching criteria (530). The matching criteria may be the same or different from those described above with respect to FIGS. 3 and 4. The processor iterates through each of the keywords in the obtained normalization transcription recording the results of the comparisons to the words in the spoken message transcription being examined. Based on the recorded results, a determination that the matching criteria are satisfied is made by the processor.

In response to the comparison satisfying the matching criteria with the normalized transcriptions assigned to the suggested context category, a confirmation that the suggested context category is a correct context category for obtained transcription is generated (540). The auto-tagger 234 process may update or modify the data record containing the transcription. For example and with reference to the data records shown in Table 2, the updated data record may include a transcription identifier, e.g. “10”, in the ID field, the keywords of a normalized transcription N in the keywords field, and the name of the now assigned (i.e. the confirmed correct context category, and no longer the preliminarily assigned) context category in the context category (i.e. Tag) field (550). In essence, the context category identifier remains unchanged from that of the suggested caller. The updated data record is stored in the corpus 127 and/or context model 129 (for the specific context category) of data storage 120 (560).

When the comparison fails to satisfy the match criteria, one or more of the following functions may be performed by the processor. For example, the processor may forward the transcription to a system that performs manual transcription categorization (i.e. tagging), such as the manual transcription tagging 236 process of FIG. 2, or the process of automatically assigning a context category by the auto-tagger 234 process as described above with respect to FIG. 4 may be performed.

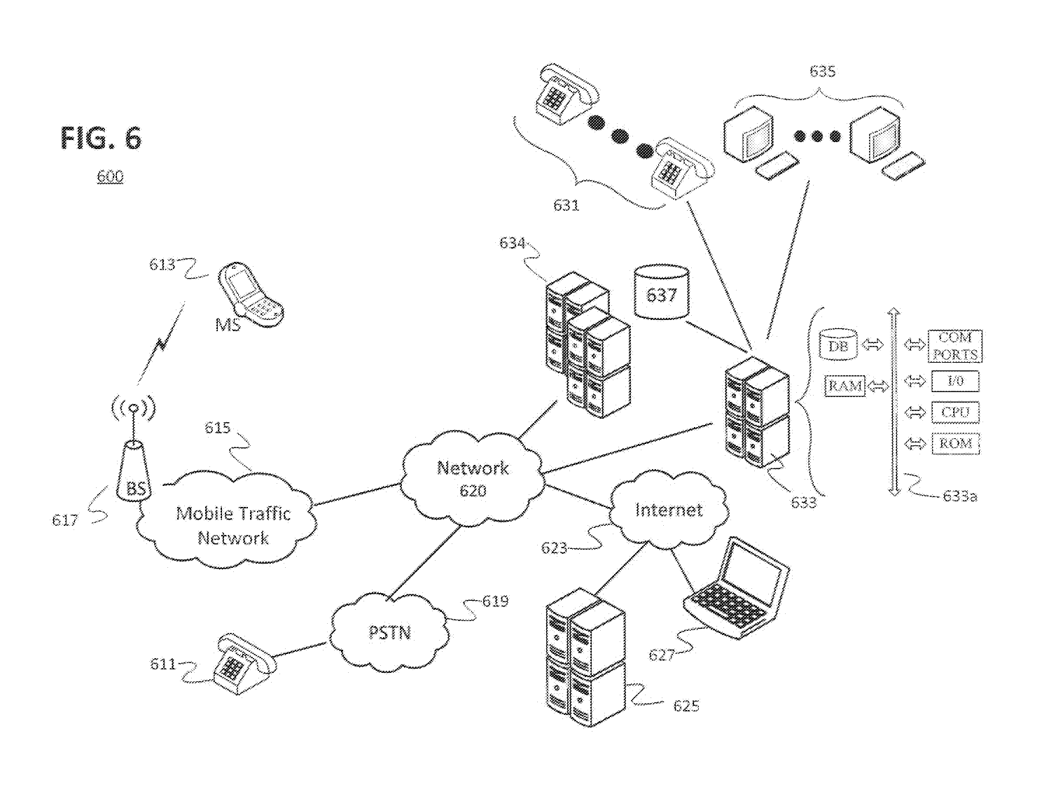

The above described processes and systems are implemented on machine configured to perform the described functions. FIG. 6 provides an illustration of a simplified functional block diagram of a computer network system that may be configured to implement the functions as described with respect to FIGS. 3-5. The computer network system 600 includes a number of different, but interconnected networks. For example, provider network 620 is connected to the mobile traffic network 615, the public switched telephone network (PSTN) 619, and the Internet network 623. Voice and data information may be exchanged between each of the respective networks 615-623.

The service provider network 620 is configured to perform a number of functions including receiving customer calls requesting assistance or information (i.e. customer support) related to services, such as e-mail, digital media content delivery, cellular telephone, Internet and the like, provided by the service provider via the servers 633 and 634. For example, voice calls may be received by the server provider network 620 from mobile stations (MS) 613 via a base station (BS) 617, mobile traffic network 615, and from the telephone 611 connected to the PSTN 619 and/or via voice-over-the-Internet from the customer user station 627 via the internet 623.

The service provider servers 634 may be configured to provide the various e-mail, digital media content delivery, cellular telephone, Internet and the like services provided by the service provider. Meanwhile, the service provider server 633 are configured to receive customer support communications, such as the voice calls as well as text, email and other forms of data communications, in which users are requesting assistance or information. The service provider servers 633 are also configured to deliver the received customer support voice calls to a telephone system 631 or chat messages to terminals 635, and may implement system 200 including a natural language call router 215, as discussed above. The service provider servers 633 and data storage 637 may be configured to provide the functions and store data records, respectively, as described above with respect to FIGS. 1-5.

A server, for example, includes a data communication interface for packet data communication. The server also includes a central processing unit (CPU), in the form of one or more processors, for executing program instructions. The server platform typically includes an internal communication bus, program storage and data storage (e.g. 637) for various data files to be processed and/or communicated by the server, although the server often receives programming and data via network communications. The hardware elements, operating systems and programming languages of such servers may be conventional in nature, for example, the servers 633 are shown to include a data communication bus 633a that is coupled to each of a processor (i.e. a central processing unit (CPU)), a read only memory (ROM); a random access memory (RAM), inputs and outputs interface (I/O), a database (DB) and communications ports (COM PORTS). Of course, the server functions may be implemented in a distributed fashion on a number of similar hardware platforms, for example, to distribute the processing load. In addition, the servers 634 and 625 may have similar hardware that is configurable to perform the functions of the respective disclosed systems.

A computer type user terminal device 635, such as a PC or tablet computers, similarly includes a data communication interface CPU, main memory and one or more mass storage devices for storing user data and the various executable programs (see FIG. 1). The various types of user terminal devices will also include various user input and output elements. A computer, for example, may include a keyboard and a cursor control/selection device such as a mouse, trackball, joystick or touchpad; and a display for visual outputs. A microphone and speaker enable audio input and output. The hardware elements, operating systems and programming languages of such user terminal devices also are conventional in nature. For example, the computer type user terminal devices 635 may be used to provide the manual transcription of received speech files, or may be used by users to perform other call routing and/or context categorization functions as described above.

In an example, a call as described above with respect to FIG. 2 may be generated by telephone 611 in PSTN 619, and is received by the service providers's customer support servers 633. The call may be processed by the natural language call router 215 process as described above. In an example, all of the processes illustrated in FIG. 2 may be performed by a system including the servers 633, the telephone receivers 631 and the computer systems 635. Each of the system components 631-635 may be collocated or may be remote from one another, or may be collocated, but with multiple instances occurring in different geographical locations, such as a European system, an Asian system, or the East coast and the West coast of the United States.

Hence, aspects of the methods of context categorization outlined above may be embodied in programming. Program aspects of the technology may be thought of as “products” or “articles of manufacture” typically in the form of executable code and/or associated data that is carried on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time fear the software programming. All or portions of the software may at times be communicated through the Internet or various other telecommunication networks. Such communications, for example, may enable loading of the software from one computer or processor into another, for example. from a management server or host computer of the service provider into the computer platform of the service provider servers 633 that will be configured to provide a call routing and context categorization system. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the context categorization processes, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim and all applications, modifications, and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may he used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method, comprising steps of:
obtaining, by a processor, a transcription of a spoken message for categorization by assigning a context category to the transcription, wherein the context category indicates a subject matter context of the transcription;
parsing the obtained transcription to identify words in the obtained transcription;
accessing, in a data storage, a corpus of categorized transcriptions, wherein the corpus of categorized transcriptions is a database containing a plurality of data records, and each data record includes a keyword field and a category field related to a categorized transcription;
retrieving a first data record of a context category from the accessed corpus of categorized transcriptions;
comparing the identified words from the obtained transcription to keywords of the retrieved first data record;
in response to a comparison result indicating a sufficient match to the obtained transcription is not found in the first data record, retrieving a second data record of the context category from the assessed corpus of categorized transcriptions;
comparing the identified words from the obtained transcription to keywords of the second data record; and
in response to the comparison yielding a match of the identified words with the second data record to sufficient degree, storing data related to the obtained transcription in a statistics processing file in the data storage.

2. The method of claim 1, further comprising steps of:
receiving a literal transcription of the spoken message;
identifying unessential words in the literal transcription, wherein the unessential words are ignored when determining the context of the literal transcription and essential words remain in the literal transcription;
generating keywords from the essential words remaining in the literal transcription; and
storing the generated keywords as a normalized transcription data record of the literal transcription, wherein the normalized transcription is the obtained transcription.

3. The method of claim 2, further comprising the steps of:
for each essential word remaining in the literal transcription:
parsing text of the essential words to determine whether the essential word is an enhanced or an unenhanced essential word,
in response to the determination that the essential word is an enhanced essential word, removing the enhancement from the text of the essential word to provide a root word;
comparing the root word or, based on a contrary result of the, determination, the unenhanced essential word to a dictionary of words;
based on the results of the comparing, modifying the root word or the unenhanced essential word to generate a shortest form of the essential word as found in the dictionary of words, wherein the shortest form of the essential word is a complete word; and
storing the shortest form of the essential word as a keyword in a data record to form the normalized transcription data record of the literal transcription.

4. The method of claim 3, further comprising:
in response to storing the shortest form of all of the essential words from the literal transcription, identifying extra occurrences of the same keyword stored in the data record; and
in response to identifying extra occurrences of the same keyword stored in the data record, deleting the extra occurrences of the keyword from the data record.

5. The method of claim 1, further comprising steps of:
receiving for the obtained transcription an assignment to a suggested context category of the transcription, wherein the context category indicates a subject matter context of the transcription;
obtaining a normalized transcription from a plurality of normalized transcriptions assigned to the suggested context category;
comparing a word in the obtained transcription to a keyword in the normalized transcription from the plurality of normalized transcriptions assigned to the suggested context category according to matching criteria; and
in response to the comparison satisfying the matching criteria with the normalized transcriptions assigned to the suggested context category, generating a confirmation that the suggested context category is a correct context category for received transcription.

6. The method of claim 5, further comprising steps of:
modifying a data record containing the obtained transcription and the suggested context category to indicate that the suggested context category is the correct context category; and
storing the modified data record in association with data records corresponding to the plurality of normalized transcriptions that have been assigned the correct context category.

7. The method of claim 1, wherein the obtained transcription is a normalized transcription.

8. The method if claim 1, wherein retrieving a first data record of a context category from the accessed corpus of categorized transcriptions comprises steps of:
identifying a first context category at a highest level of a hierarchical database; and
in response to identifying a first context category at the highest level of the hierarchical database, identifying the first data record of the context category in a level below the highest level.

9. A method, comprising steps of:
obtaining, by a processor, a normalized transcription data record including a normalized transcription of a spoken message;
comparing keywords in the normalized obtained transcription according to matching criteria to keywords in a normalized transcription assigned to a first context category of a plurality of context categories, wherein each of the context categories includes a plurality of context model data records;
in response to the keyword comparison satisfying the matching criteria with the categorized, normalized transcriptions assigned to the first context category, assigning the normalized obtained transcription to the first context category;
generating a new context model data record including the normalized transcription data record with an indication of the assignment of the normalized transcription to the first context category; and
storing the new context model data record in relation with prior context model data records included in the first context category.

10. The method of claim 9, further comprising:
assigning the new context model data record to a single context category of a plurality of context categories, wherein the new context model data record is one of a plurality of data records in the single context category, and
populating the new context model data record with keywords that indicate a subject matter context of the normalized transcription and the single context category to which the context model data record is assigned.

11. The method of claim 9, further comprising steps of:
indicating the matching criteria are satisfied when the comparing keywords yields:
a subset match in which the keywords in the categorized transcription includes all of the keywords in the normalized obtained transcription, or
a superset match in which the normalized obtained transcription includes all of the keywords in the categorized transcription;
generating an indication of whether subset match or superset match criteria have been satisfied by the comparison; and
based on the generated indication, performing another comparison to find keywords in the normalized obtained transcription that satisfy matching criteria that is different from the generated indication.

12. The method of claim 9, wherein the step of obtaining a normalized transcription data record, comprises the steps of:
receiving a literal transcription of the spoken message;
identifying unessential words in the literal transcription, wherein the unessential words are ignored when determining the context of the literal transcription and essential words are determined from words remaining in the literal transcription;
generating keywords from the essential words remaining in the literal transcription; and
storing the generated keywords as a normalized transcription data record of the literal transcription.

13. The method of claim 12, wherein the step of generating keywords, comprises the steps of:
identifying an essential word having an enhancement;
removing the enhancement from the text of the essential word to provide a root word;
comparing the root word to a dictionary of words;
based on the results of the comparing, modifying the root word to generate a shortest form of the essential word as found in the dictionary of words, wherein the shortest form of the essential word is a complete word; and
storing the shortest form of the essential word as a keyword in a data record to provide the normalized transcription data record of the literal transcription.

14. The method of claim 13, further comprising:
prior to storing the shortest form of the essential word, analyzing the data record to identify any duplicates of the shortest form of the essential word in the keywords already stored in the data record; and
in response to identifying a duplicate of the shortest of the shortest form in the keywords already stored in the data record, leave the keyword in the data record and discard the shortest form of the essential word.

15. The method of claim 12, wherein the step of generating keywords, comprises the steps of;
identifying an essential word as an unenhanced essential word;
comparing the unenhanced essential word to a dictionary of words;
based on the results of the comparing, modifying the unenhanced essential word to generate a shortest form of the essential word as found in the dictionary of words, wherein the shortest form of the essential word is a complete word; and
storing the shortest form of the essential word as a keyword in a data record to provide the normalized transcription data record of the literal transcription.

16. A method, comprising steps of:
receiving, by a processor, a transcription of a spoken message including an assignment to a suggested context category of the transcription, wherein the context category indicates a subject matter context of the transcription;
obtaining a normalized transcription from a plurality of normalized transcriptions assigned to the suggested context category;
comparing a word in the received transcription to a keyword in the normalized transcription from the plurality of normalized transcriptions assigned to the suggested context category according to matching criteria; and
in response to an indication of the comparison satisfying the matching criteria with the normalized transcriptions assigned to the suggested context category, generating a confirmation that the suggested context category is a correct context category for received transcription.

17. The method of claim 16, further comprising steps of:
modifying a data record containing the received transcription and the suggested context category to indicate that the suggested context category is the correct context category; and
storing the modified data record in association with data records corresponding to the plurality of normalized transcriptions that have been assigned the correct context category.

18. The method of claim 16, further comprising steps of:
receiving as an input natural language speech data; and
receiving an input providing a suggested assignment of the received input natural language speech to a context category, wherein the source of the suggested assignment is the same source as the natural language speech data.

19. The method of claim 16, wherein the comparing a word in the received transcription comprises steps of:
determining a first criterion of the matching criteria are satisfied when the comparison yields:
a subset match in which the keywords in the received transcription includes all of the keywords in the normalized obtained transcription, or
a superset match in which the normalized obtained transcription includes all of the keywords in the received transcription;
generating an indication of whether a subset match or a superset match criteria has been satisfied by the comparison;
based on the generated indication, performing another comparison to find keywords in the received transcription that satisfy a second criterion of the matching criteria that is different from the generated indication; and
in response to the second criterion of the matching criteria being satisfied, generate the indication of the comparison satisfying the matching criteria.

20. The method of claim 16, further comprising:
forwarding a data record including the received transcription and an indication of the confirmed correct context category to a data storage; and
retrieving the data record for statistical processing of the recognition results.
